(19) United States
(12) Patent Application Publication
(10) Pub. No.: US 2008/0150251 A1
(43) Pub. Date: Jun. 26, 2008

(54) Recreational vehicle step support

(76) Inventors: Brian Roth, St. Helens, OR (US); Debra Roth, St. Helens, OR (US)

Correspondence Address: K.M. RYLANDER;RYLANDER & ASSOCIATES, 406 West 12th Street, Vancouver, WA, 98660, US

(21) Appl. No.: 11/644,762

(22) Filed: Dec. 22, 2006

(51) Int. Cl. B60R 3/00

(52) U.S. Cl. 280/166

(57) ABSTRACT

A recreational vehicle step support includes a ground member that rests upon the ground or surface, a telescoping extension member, connected to and supported by the ground member and normal to the ground or surface, a locking member for securing the extension member at varying heights, and a contact member, connected to and supported by the extension member and the contact member supports and stabilizes a recreational vehicle step. The locking member may be a nut. The contact member may be a nut and bolt, or a rest. The rest may be curved or angled. A method for providing support and stability to a recreational vehicle step including the steps of: disengaging a set of recreational vehicle steps from a stored position in preparation for use; adjusting the height of a recreational vehicle step support to match the height of an attachment site; and connecting a recreational vehicle step support to the recreational vehicle steps.

### FIELD OF THE INVENTION

Applicant's recreational vehicle step support relates to step supports and more particularly, to recreational vehicle step supports.

### BACKGROUND

Recreational vehicles typically have a carriage that is high off the ground, requiring steps to assist the user in entering or exiting the vehicle. Such steps may be attached to the recreational vehicle in numerous styles including: stationary, removable, sliding, and folding. Recreational vehicle steps must be small enough to remain in place during vehicle locomotion, flexible enough to be folded and stored high off the ground, or weak enough to be removed prior to and in preparation for vehicle locomotion. These limiting factors result in recreational vehicle steps that move, vibrate and/or rotate during use making descent or ascent more difficult for the user. Recreational vehicle users with special needs, such as older users, users with disabilities and overweight users, may find the instability of the recreational vehicle steps entirely prohibitive of entering the vehicle. Furthermore, recreational vehicles are very likely to be parked on uneven surfaces during use or storage. Campground sites, in particular, may not be level or even. The user, however, still requires stable, supported recreational vehicle steps in order to enter or exit the vehicle. Consequently, additional step support is often necessary, even when the recreational vehicle steps have integral support. Thus, there is a need for a recreational vehicle step support that stabilizes and secures the recreational vehicle steps.

A number of devices have provided recreational vehicle steps, but lack the additional support and stability, as well as allowing the user to determine the support location, provided by removably attachable recreational vehicle step supports. Presently known art attempts to address this problem, but has not completely solved the problem. The following represents a list of known related art:

| Reference: | Issued to: | Date of Issue: |
|---|---|---|
| U.S. Pat. No. 5,941,342 | Lee | Aug. 24, 1999 |
| U.S. Pat. No. 5,803,475 | Dick | Sep. 8, 1998 |
| U.S. Pat. No. 4,720,116 | Williams et. al. | Jan. 19, 1988 |
| U.S. Pat. No. 4,264,084 | Telles | Apr. 28, 1981 |
| U.S. Pat. No. 4,021,071 | Norman | May 3, 1977 |
| U.S. Pat. No. 3,463,509 | Schiffner | Aug. 26, 1969 |
| U.S. Pat. No. 3,462,170 | Smith et. al. | Aug. 19, 1969 |
| U.S. Pat. No. 2,990,148 | James | Jun. 27, 1961 |
| U.S. Pat. No. 2,611,466 | Biggert et. al. | Sep. 23, 1952 |

The teachings of each of the above-listed citations (which does not itself incorporate essential material by reference) are herein incorporated by reference. None of the above inventions and patents, taken either singularly or in combination, is seen to describe the instant invention as claimed.

U.S. Pat. No. 5,941,342 to Lee teaches a folding staircase having a pair of horizontal link bars and a pair of vertical linked bars that pivot, permitting the stairs to fold. The folding staircase can be fixed to a vehicle via support brackets, guide members, an upper bar and a hook. The folding staircase utilizes a support member with a ground member to support the staircase on the ground when unfolded for use.

U.S. Pat. No. 5,803,475 to Dick teaches a receiver hitch step attachment for a vehicle having an existing tubular receiver hitch, having a drawbar to slide onto the receiver hitch, an upper and a lower step, connecting structure to join the steps to the drawbar, and a stabilizing unit. The stabilizing unit has a mounting bracket or base of a general U-shape, an upper sleeve coupled to the bracket, and a lower extendable section with a foot for placement on the ground.

U.S. Pat. No. 4,720,116 to Williams et. al. teaches a storable stairway and platform apparatus for recreational vehicles, having a horizontally extending mounting means, a platform means attached to and can pivot from the mounting means, stairway means pivotally connected to the platform means and itself having stairs, and opposing scissor linkages for folding, leveling means to level the apparatus to the ground, and a leg. The leg is pivotally connected to the lower end of the stationary side bar of the lowermost step and to the stationary side bar of an overlying step or the platform means.

U.S. Pat. No. 4,264,084 to Telles teaches a fold-up camper step assembly for attachment to a vehicle wall, having a platform, a step structure, pivoting means for attaching the step structure the platform, a latching means to optionally prevent the step assembly from pivoting, and a pair of collapsible auxiliary telescoping support legs removably mounted to the platform pivotable at a point on the platform such that the legs can extend perpendicular from the platform or collapse horizontally underneath the platform.

U.S. Pat. No. 4,021,071 to Norman teaches a self-storing step structure for vehicular mounting, having mounting brackets connected to the tailgate of a truck; a first step section pivotally connected to the mounting brackets such that the steps can be pivoted 180 degrees; a pair of rails with at least one step member extending between them, a step member extending between and engaged with the rails; an extensible step section similar to the first step section and further having a step platform and a web resting slidably upon the first set of rails; a means for adjusting the step sections, and a foot plate.

U.S. Pat. No. 3,463,509 to Schiffner teaches a folding camper step having a step portion, a pair of perpendicular supports fixed thereto, hinges securing the supports to the vehicle, diagonal supports secured between the tops of the perpendicular supports and the sides of the step, legs pivotally secured to the diagonal supports, the legs having aligned holes lined up with holes on the diagonal supports, the pivotal connection between the legs and the diagonal supports consisting of a removable bolt and a wing nut. The legs may be provided with pivotally mounted foot portions.

Still other features would be desirable in recreational vehicle steps and supports. For example, even if the recreational vehicle steps receive some support inherent in their structure, such as when the steps themselves or their integral supports come into contact with the ground, additional stability and support may be needed. Additionally, the prior art does not allow the user to choose the placement of any support or additional support for the steps.

Thus, while the foregoing body of art indicates it to be well known to have a set of recreational vehicle steps and integral supports which may rest on the ground, the art described above does not teach or suggest a recreational vehicle step support which has the following combination of desirable features: (1) providing additional support if the step already possesses a means of support, (2) allowing the user to determine the location of the support, (3) permitting the user to determine if a recreational vehicle step requires additional support, (4) permitting the user to determine how much additional support recreational vehicle steps require, (5) support that can accommodate a variety of vehicle step styles, (6) support that can be easily removed from the steps, and (7) support that can be easily assembled.

### SUMMARY AND ADVANTAGES

A recreational vehicle step support includes a ground member that rests upon the ground or surface, a telescoping extension member connected to and supported by the ground member and normal to the ground or surface, a locking member for securing the extension member at varying heights, and a contact member, connected to and supported by the extension member which supports and stabilizes a recreational vehicle step. The locking member may be a nut. The contact member may be a nut and bolt, or a rest. The rest may be curved or angled. A method for providing support and stability to a recreational vehicle step including the steps of disengaging a set of recreational vehicle steps from a stored position in preparation for use, adjusting the height of a recreational vehicle step support to match the height of an attachment site, and connecting a recreational vehicle step support to the recreational vehicle steps.

Applicant's recreational vehicle step support presents numerous advantages, including: (1) providing support to a recreational vehicle step, (2) providing additional support if the step already possesses a means of support, (3) permitting the user to determine if a recreational vehicle step requires additional support, (4) permitting the user to determine how much additional support recreational vehicle steps require, (5) allowing the user to determine the location of the support, (6) support that can accommodate a variety of vehicle step styles, (7) support that can be easily removed from the steps, and (8) support that can be easily assembled to support the steps.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a front view of an embodiment of the invention.

FIG. 2 shows a back view of an embodiment of the invention.

FIG. 3 shows a front view of an alternate embodiment of the invention.

FIG. 4 shows a side view of an embodiment of the top portion of the invention.

FIG. 5 shows a side view of an alternate embodiment of the top portion of the invention as depicted in FIG. 3.

FIG. 6 shows a front view of an embodiment of the invention, as depicted in FIGS. 1 and 2, in use.

FIG. 7 shows a partial front view of an embodiment of the invention, as depicted in FIG. 3, in use.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

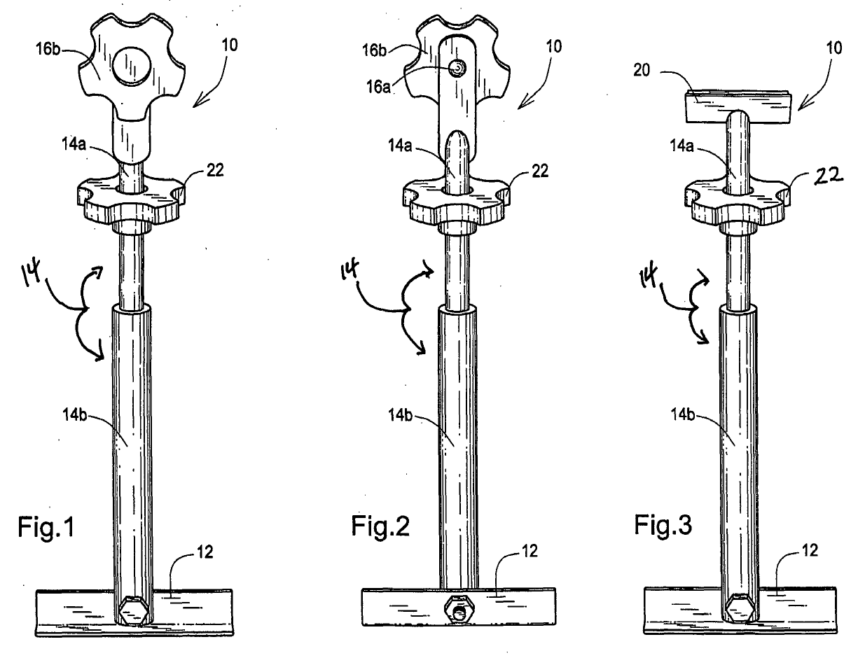

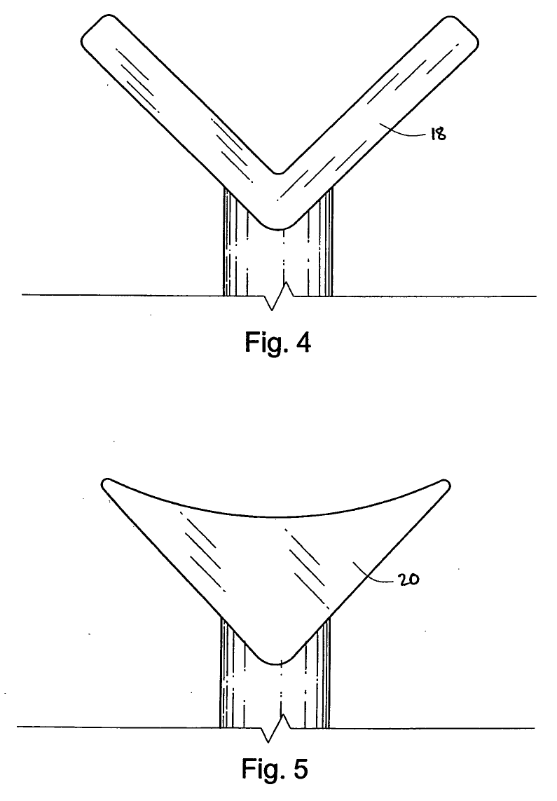

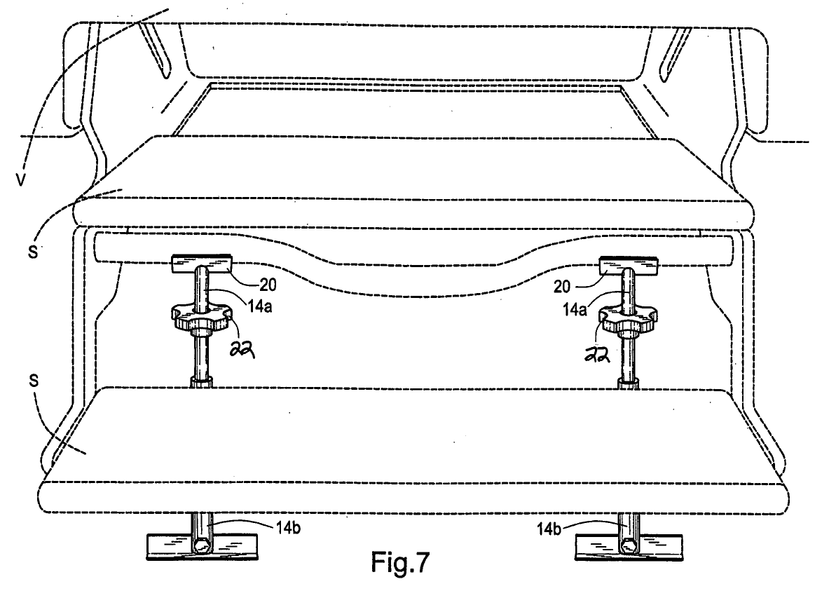

As shown in FIGS. 1-3, a recreational vehicle step support 10 includes a ground member 12 that rests upon the ground or surface, a telescoping extension member 14, connected to and supported by the ground member 12 and normal to the ground or surface, a locking member 22 for securing the extension member at varying heights, and a contact member, connected to and supported by the extension member 14. Contact member is a bolt 16a in FIGS. 1-2, a bolt 16a with a nut 16b in FIG. 2, a curved rest 20 in FIGS. 3 and 7, and an angled rest 18 in FIG. 4). One of ordinary skill in the art would realize that one recreational vehicle step support 10 may be used or multiple recreational vehicle step supports 10 may be used, limited only by space constraints around the vehicle stairs S.

As shown in FIGS. 1-3, 6-7, the ground member 12, preferably a rectangular bar, is fixed to the extension member 14 so that when the ground member 12 rests upon the ground or surface, the ground member 12 supports the extension member 14. Ground member 12 can also be disk shaped or other suitable shape which provides a base of support for the extension member 14 to rest upon with weight. The ground member 12 can be integral to the extension member 14 or fixed to the extension member 14 via numerous ways, including: nuts, bolts, clamps, dowels, pins, channels, fasteners, clips, apertures, rivets, screws, grooves, joints, latches, links, nails, nuts, bolts, tubes, strings, wires, ropes, cords, adhesives, knobs, apertures, dowels, recesses, slits or slots.

As shown in FIGS. 1-3, 6-7, the telescoping extension member 14 is preferably a cylindrical arm extending away from the ground member 12, and perpendicular to the ground or surface when in use. One of ordinary skill in the art would realize that the extension member 14 will not be perpendicular to the ground or surface when the recreational vehicle V is located on an incline or slope. The extension member's 14 cylindrical upper portion 14a is preferably threaded and the cylindrical lower portion 14b preferably un-threaded. The upper portion 14a preferably has a smaller diameter than the lower portion 14b, such that the upper portion 14a is partially housed inside the lower portion 14b.

Contact member is connected to extension member 14 at distal end from the ground member 12, and supports and stabilizes the recreational vehicle support step S. Preferably contact member is a curved rest 20 (FIGS. 3, 5 and 7). Those with skill in the art would know that contact member can be, alone or in combination a curved rest 20, an angled rest 18 (as depicted in FIG. 4), a nut 16b and a bolt 16a (as depicted in FIGS. 1-2 and 6), clamps, dowels, pins, channels, fasteners, clips, apertures, rivets, screws, grooves, joints, latches, links, nails, nuts, bolts, tubes, strings, wires, ropes, cords, knobs, apertures, dowels, recesses, slits or slots. Curved rest 20, is a half pipe which connects to the extension member 14 perpendicular to the orientation of the half pipe, as shown in FIGS. 3, 5, and 7. Angled rest 18, is a “Y” shaped piece, as shown in FIG. 4, which connects to the extension member 14 at the bottom of the “Y”, allowing the portion of the step S which contacts the recreation vehicle step support 10 to rest in the arms of the “Y”. An opening is preferable in the extension member 14 when the contact member requires an opening in which to be secured to the extension member 14, such as when the contact member is a nut 16b and a bolt 16a. Similar to the ground member 12, the contact member can be integral to the extension member 14 or fixed to the extension member 14 via numerous ways, including: nuts, bolts, clamps, dowels, pins, channels, fasteners, clips, apertures, rivets, screws, grooves, joints, latches, links, nails, nuts, bolts, tubes, strings, wires, ropes, cords, adhesives, knobs, apertures, dowels, recesses, slits or slots.

The locking member 22 may be a nut, as shown in FIGS. 1-3, 6-7. Preferably, as depicted in the aforementioned figures, the locking member 22 is a wing nut, having exaggerated lobes, located at the point the upper, threaded portion of the extension member 14a telescopes into the lower, non-threaded portion of the extension member 14b. The locking member 22 may include: nuts, bolts, clamps, dowels, pins, channels, fasteners, clips, apertures, rivets, screws, grooves, joints, latches, links, nails, nuts, bolts, tubes, strings, wires, ropes, cords, adhesives, knobs, apertures, dowels, recesses, slits or slots.

In use, the height of the extension member 14 is adjustable by pulling the telescoping portions 14a of the extension member 14 upward to increase the extension member 14 length when the recreational vehicle step S requiring support is high off the ground or surface. Causing less of the upper portion 14a to telescope into the lower portion 14b, exposes more of the upper portion 14a, thereby increasing the overall height of the extension member 14. The user then secures the height of the extension member 14 by activating the locking member 22, e.g., tightening a nut located at the point the exposed upper extension member 14a meets the lower extension member 14b. Correspondingly, the user can adjust the height of the extension member 14 by pushing the telescoping portions 14a of the extension member 14 downward to decrease the extension member 14 length when the recreational vehicle step S requiring support is low off the ground or surface. Causing more of the upper portion 14a to telescope into the lower portion 14b, exposes less of the upper portion 14a, thereby decreasing the overall height of the extension member 14. The user secures the height of the extension member 14 with the locking member 22.

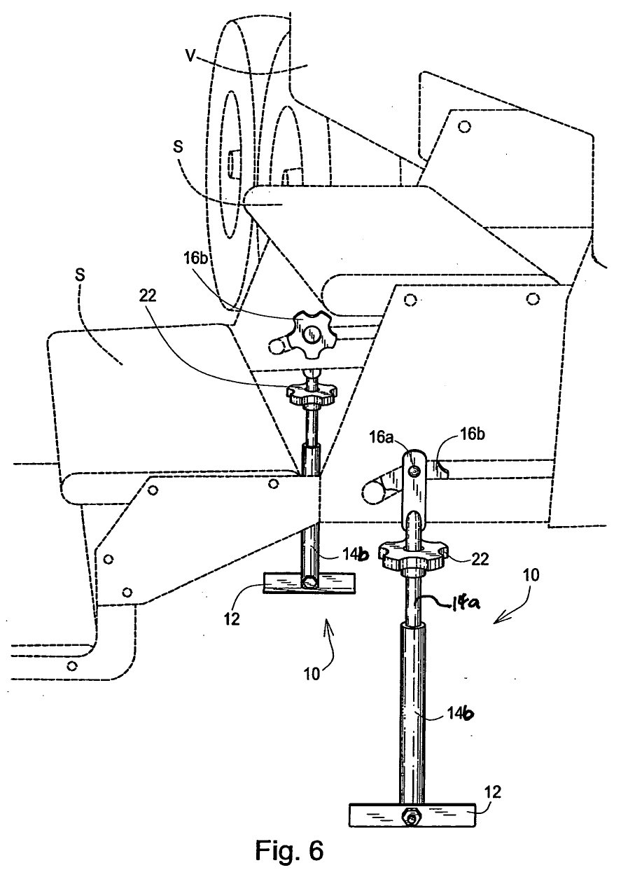

A method for providing support and stability to a recreational vehicle step S includes the steps of: disengaging a set of recreational vehicle steps S from a stored position in preparation for use; adjusting the height of a recreational vehicle step support 10 to match the height of an attachment site; and connecting a recreational vehicle step support 10 to the recreational vehicle steps S. Recreational vehicle steps S typically fold upwards, underneath a recreational vehicle door, for travel. The steps S are often pulled or pushed down and out into an extended position, as seen in FIGS. 6-7, for use when the vehicle is stationary. The attachment site for a recreational vehicle step support 10 may be underneath a support or pull bar (FIG. 7), at an opening in the side of the steps S (FIG. 6), or underneath a step S.

In operation in one embodiment, the recreational vehicle steps S are placed into an extended position for use. The user then adjusts the height of the extension member 14, locking it at the desired height by tightening a wing nut having exaggerated lobes (an embodiment of the locking member 22). Next, the recreational vehicle step support 10 is aligned underneath the step's S pull bar such that the pull bar is supported by a rest 20 (an embodiment of the contact member). In order to ensure a tight fit between the rest and the pull bar, the user may need to readjust the height of the extension member 14. Additionally, the user can ensure that the ground member 12 remains stable, particularly if the recreational vehicle V is parked on wet ground, by placing a rigid material underneath it, such as a wooden board or a cement block. In preparation for travel, the user can remove the recreational vehicle step support 10 by adjusting the height of the extension member 14, which may be accomplished by loosening the wing nut. The rest is disengaged from the pull bar when the height of the extension member 14 is reduced and the user can then remove the recreational vehicle step support 10 from the vicinity of the steps S, retract the steps S for storage, and commence travel.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

We claim:

1. A recreational vehicle step support, comprising:
a ground member that rests upon the ground or surface;
a telescoping extension member, connected to and supported by said ground member and normal to the ground or surface;
a locking member for securing said extension member at varying heights; and
a contact member, such that said contact member is connected to and supported by said extension member and said contact member supports and stabilizes a recreational vehicle step.

2. The recreational vehicle step support of claim 1, wherein said locking member comprises a nut.

3. The recreational vehicle step support of claim 1, wherein said contact member comprises a nut and bolt.

4. The recreational vehicle step support of claim 1, wherein said contact member comprises a rest.

5. The recreational vehicle step support of claim 4, wherein said rest is curved.

6. The recreational vehicle step support of claim 4, wherein said rest is angled.

7. A recreational vehicle step support, comprising:
a ground member that rests upon the ground or surface;
a telescoping extension member, connected to and supported by said ground member and normal to the ground or surface;
a locking member for securing said extension member at varying heights; and
an attachment means for securing said extension member to a recreational vehicle step.

8. The recreational vehicle step support of claim 7, wherein said attachment means comprises a nut and a bolt.

9. The recreational vehicle step support of claim 7, wherein said attachment means comprises a rest.

10. The recreational vehicle step support of claim 9, wherein said rest is curved.

11. The recreational vehicle step support of claim 9, wherein said rest is angled.

12. A method for providing support and stability to a recreational vehicle step, comprising the steps of:
disengaging a set of recreational vehicle steps from a stored position in preparation for use;
adjusting the height of a recreational vehicle step support to match the height of an attachment site; and
connecting a recreational vehicle step support to said recreational vehicle steps.
